(19) United States
(12) Patent Application Publication
(10) Pub. No.: US 2012/0160648 A1
(43) Pub. Date: Jun. 28, 2012

(54) KEYSWITCH AND KEYBOARD

(76) Inventors: Ling-Hsi Chao, Taoyuan (TW); Po-Wei Tsai, Taoyuan (TW); Chih-Chung Yen, Taoyuan (TW)

(21) Appl. No.: 13/337,273

(22) Filed: Dec. 26, 2011

(30) Foreign Application Priority Data
Dec. 27, 2010 (TW) 099225122

(51) Int. Cl. H01H 3/12

(52) U.S. Cl. 200/341

(57) ABSTRACT

A keyswitch includes a cover, a frame, a keycap, two connecting parts, and a base. The cover has an opening. The frame is disposed under the cover. The base is disposed under the frame. The keycap is located in the opening. The keycap has two opposite edges. The two connecting parts are connected between the two opposite edges and the frame. The cover abuts against the two connecting parts to restrain the keycap from moving up.

### BACKGROUND OF THE INVENTION

1. Field of the Invention

The invention relates to a keyswitch and a keyboard, and more particularly, to a keyswitch using cover to abut against the connecting parts between the keycap and the frame and a keyboard using such keyswitch.

2. Description of the Prior Art

Keyboards are necessary for inputting text, symbols, or numbers in the common computer using environment, and FIG. 2 is an illustration of the cross-sectional view along X-X′ in FIG. 1.

Please refer to FIG. 1 and FIG. 2. FIG. 1 is an illustration of the top view of a keyswitch 1 according to the prior art, and FIG. 2 is an illustration of the cross-sectional view of the keyswitch 1 along X-X′ in FIG. 1. As shown in FIG. 1 and FIG. 2, the keyswitch 10 includes a frame 10, a keycap 12, a connecting part 14, a base 16, and an elastic piece 18. The frame 10 has an opening 100 in which the keycap 12 is located. The base 16 is disposed under the frame 10 and the elastic piece 18 is disposed between the keycap 12 and the base 16 for providing recovery force toward the keycap 12 and sense of click as the keycap 12 is forced to move up and down with respect to the base 16. The connecting part 14 connects between an edge 121 of the keycap 12 and the frame 10 so that the keyswitch 10 is a cantilever beam type. The elastic piece 18 is utilized for steadying the movement of the keycap 12. In the prior art, however, there is no structure that can prevent the keycap 12 from overly moving upward. The keycap 12 is highly possible to have excessive upward bounce once being pressed, released, and then pushed by the elastic piece 18, which easily causes fracture of the connecting part 14 and breaks the keycap 12.

### SUMMARY OF THE INVENTION

Hence, one purpose of the invention is to provide a keyswitch and a keyboard, which use a cover to abut against the connecting parts connecting between the keycap and the frame so as to restrain the keycap from moving upward and out of the cover.

According to one embodiment of the invention, a keyswitch is provided. The keyswitch includes a cover, a frame, a keycap, two connecting parts, and a base. The cover includes an opening. The frame is disposed under the cover. The keycap is located in the opening and includes two opposite edges. Each of the connecting parts connects between one corresponding edge and the frame respectively and is abutted by the cover such that the keycap is restrained from moving upward. The base is disposed under the frame.

Another purpose of the invention is to provide a keyboard, which include the base and a plurality of keyswitches disposed thereon. One of the keyswitches includes a cover, a frame, a keycap, and two connecting parts. The cover includes an opening. The frame is disposed under the cover. The keycap is located in the opening and includes two opposite edges. Each of the connecting parts connects between one corresponding edge and the frame respectively and is abutted by the cover such that the keycap is restrained from moving upward.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of the top view of a keyswitch according to the prior art.

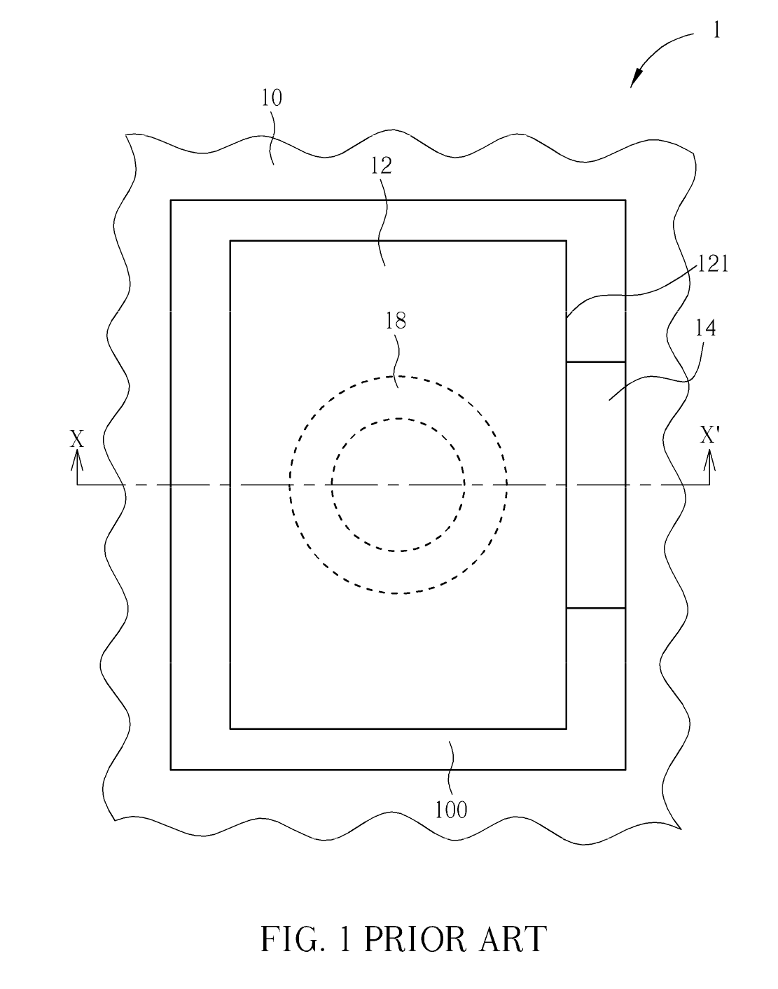

FIG. 2 is an illustration of the cross-sectional view of the keyswitch along X-X′ in FIG. 1.

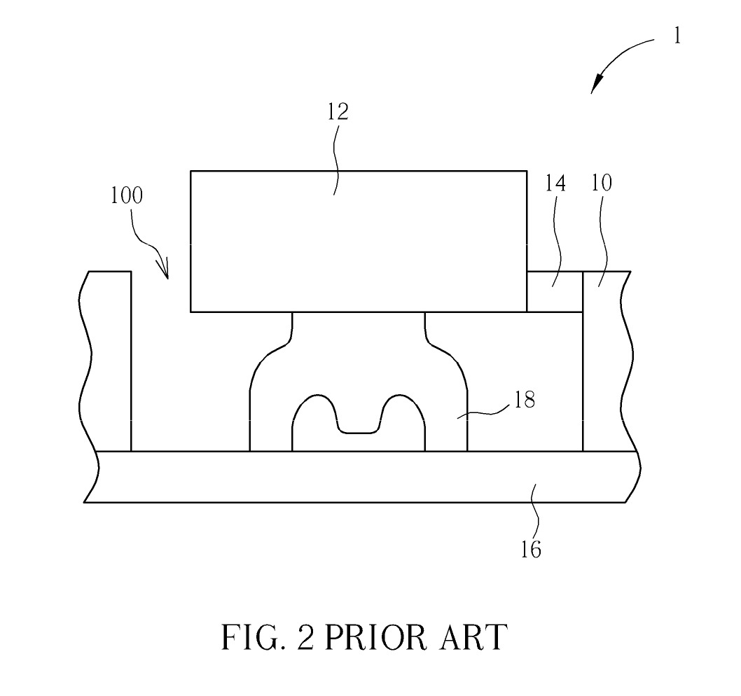

FIG. 3 is an illustration of a keyboard according to a first embodiment of the invention.

FIG. 4 is an illustration of the top view of one keyswitch of the keyboard in FIG. 3.

FIG. 5 is an illustration of the cross-sectional view of the keyswitch along Y-Y′ in FIG. 4.

FIG. 6 is an illustration of the top view of one keyswitch according to a second embodiment of the invention.

FIG. 7 is an illustration of the cross-sectional view of the keyswitch along P-P′ in FIG. 6.

FIG. 8 is an illustration of the top view of one keyswitch according to a third embodiment of the invention.

FIG. 9 is an illustration of the cross-sectional view of the keyswitch along Z-Z′ in FIG. 8.

### DETAILED DESCRIPTION

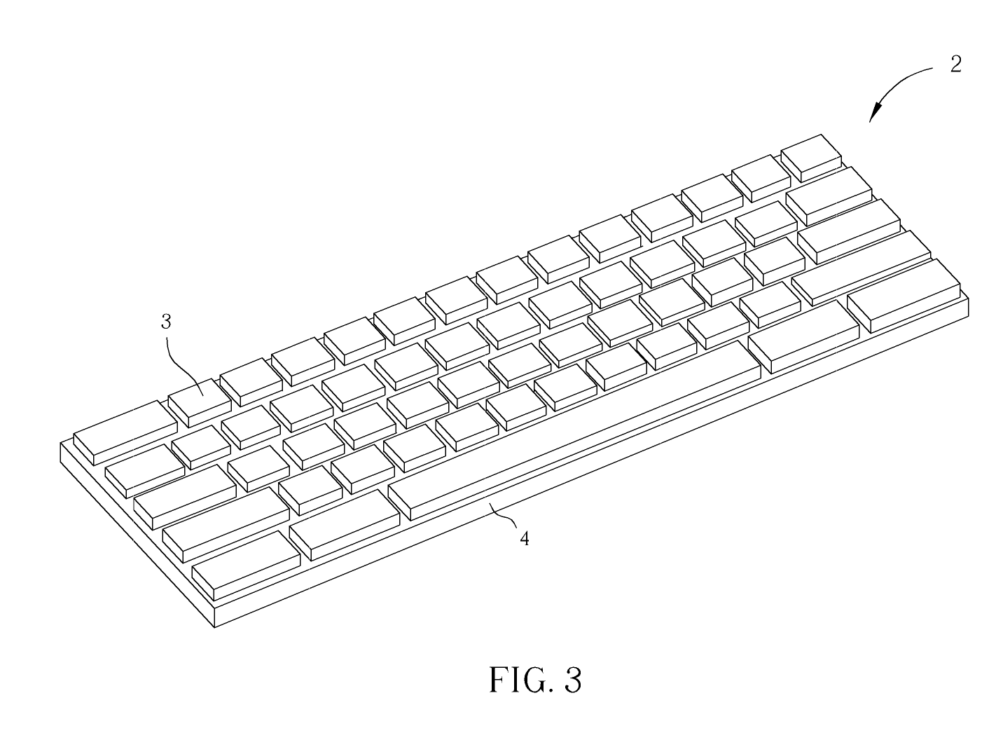

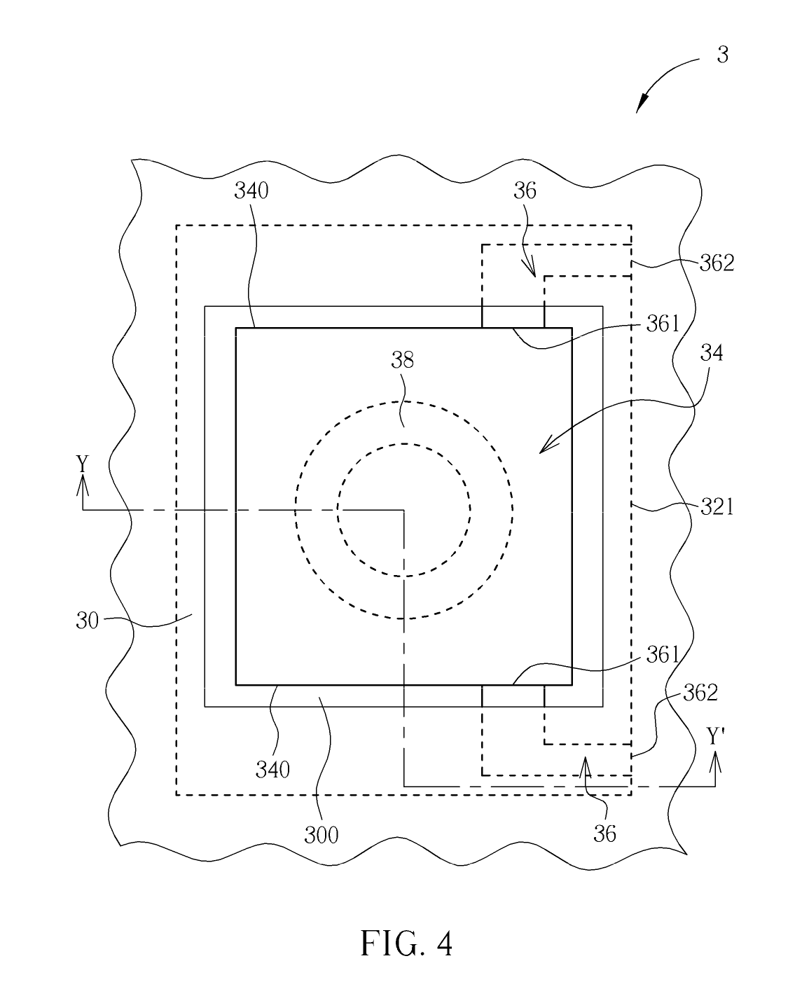

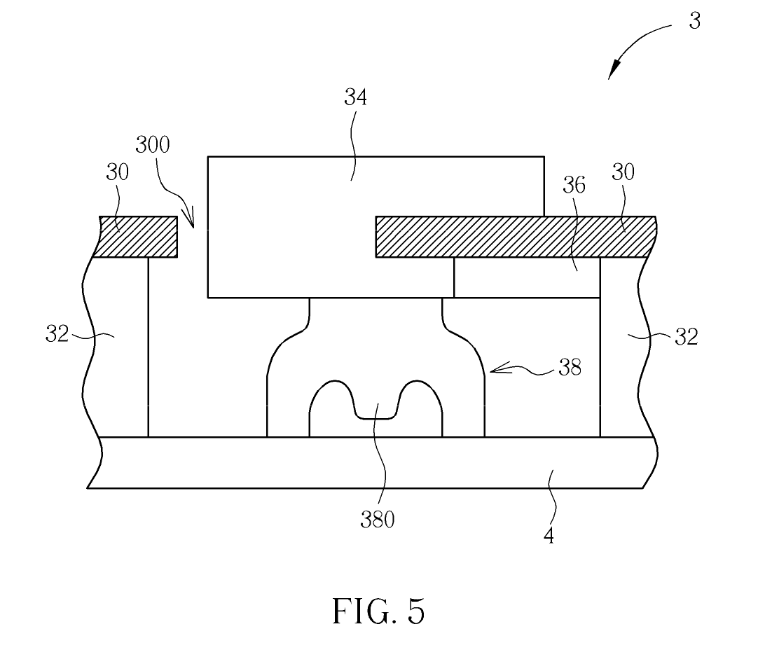

Please refer to FIG. 3. FIG. 3 is an illustration of a keyboard 2 according to a first embodiment of the invention. As shown in FIG. 3, the keyboard 2 includes a plurality of keyswitches 3 and a base 4. Please refer to FIG. 4 and FIG. 5. FIG. 4 is an illustration of the top view of one keyswitch 3 of the keyboard 2 in FIG. 3, and FIG. 5 is an illustration of the cross-sectional view of the keyswitch 3 along Y-Y′ in FIG. 4. The keyswitch 3 includes a cover 30, a frame 32, a keycap 34, two connecting parts 36, an elastic piece 38, and a base 4. The cover 30 has an opening 300 in which the keycap 34 is located. The keycap 34 has similar and slightly smaller contour as the opening 300 but the contour of the keycap 34 and the opening 300 shown in the figures should not be limited the scope of the invention. The frame 32 is disposed under the cover 30, the base 4 is disposed under the frame 32, and the elastic piece 38 is disposed between the keycap 34 and the base 4. The keycap 34 includes two opposite edges 340 and each of the two connecting parts 36 connects between one corresponding edge 340 of the keycap 34 and the frame 32 respectively. In this embodiment, the two connecting parts 36 are L-shape, with their first end nodes 361 connecting to corresponding edges 340 and their second end nodes 362 connecting to a linking edge 321 of the frame 32, where the linking edge 321 not facing edges 340 of the keycap 34. For an embodiment of the invention, the frame 32, the keycap 34, and the two connecting parts 36 may be monolithically formed as one piece, while in other embodiments of the invention, these components may also be individually separated.

Referring FIG. 4 and FIG. 5, the two connecting parts 36 are partially under the cover 30. As the keycap 34 is forced to move downward and bounced back by the elastic piece 38, the two connecting parts 36 are abutted by the cover 30 such that the keycap 34 is restrained from move upward and out of the cover 30.

Practically, the keyswitch 3 may further include a circuit board, which is not shown in the figures and is disposed on the base 4. The elastic piece 38 has a triggering part 380 facing a corresponding switch, such as a membrane switch, on the circuit board. The elastic piece 38 may be a rubber dome, but should not be regarded as a limit, that provides recovery force when the keycap 34 is pressed downward and also provides sense of click toward the keycap 34.

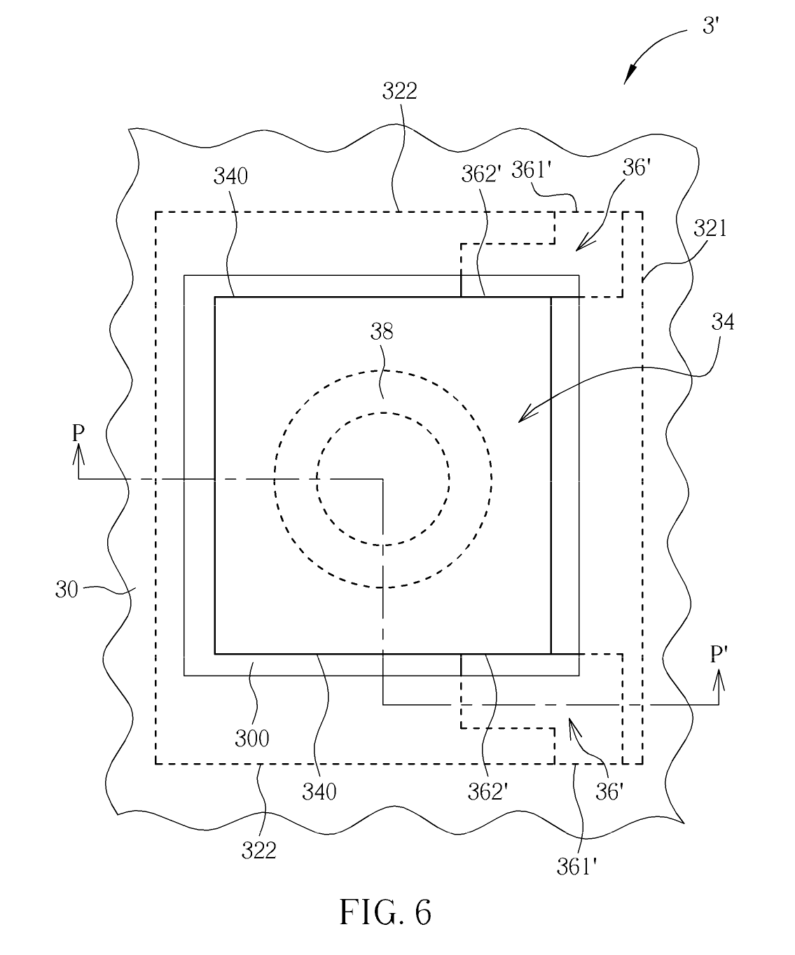

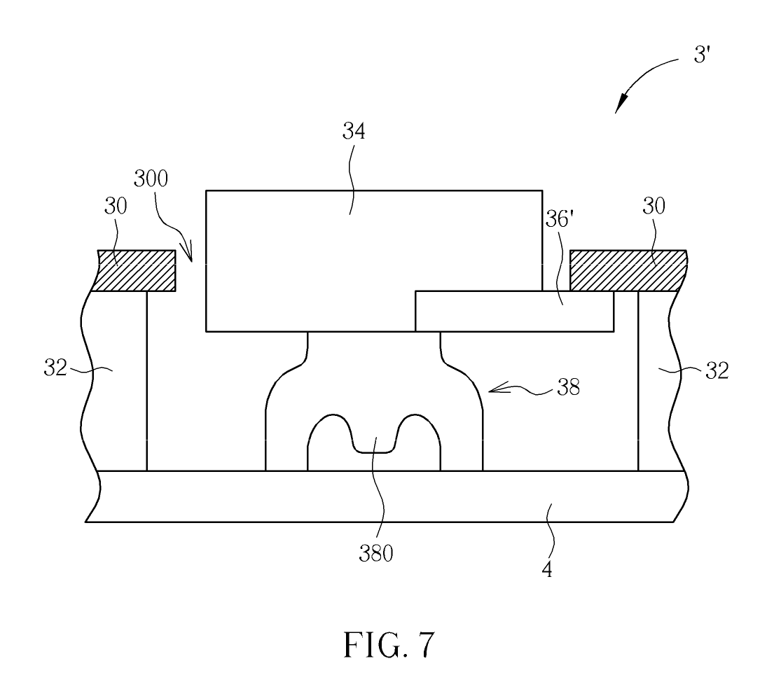

Please refer to FIG. 6 and FIG. 7, FIG. 6 is an illustration of the top view of a keyswitch 3′ according to a second embodiment of the invention, and FIG. 7 is an illustration of the cross-sectional view of the keyswitch 3′ along P-P′ in FIG. 6. In the second embodiment, the two connecting parts 36′ are L-shape. Additionally, both connecting parts 36′ have first end nodes 361′ connecting to the corresponding linking edges 322 of the frame 32 that face the two edges 340 of the keycap 34, and have sides 362′, locating opposite to the first end nodes 361′, connecting to the corresponding edges 340 of the keycap 34. Similar with the previous embodiment, as the keycap 34 is forced to move downward and bounced back by the elastic piece 38, the two connecting parts 36′ are abutted by the cover 30 such that the keycap 34 is restrained from move upward and out of the cover 30.

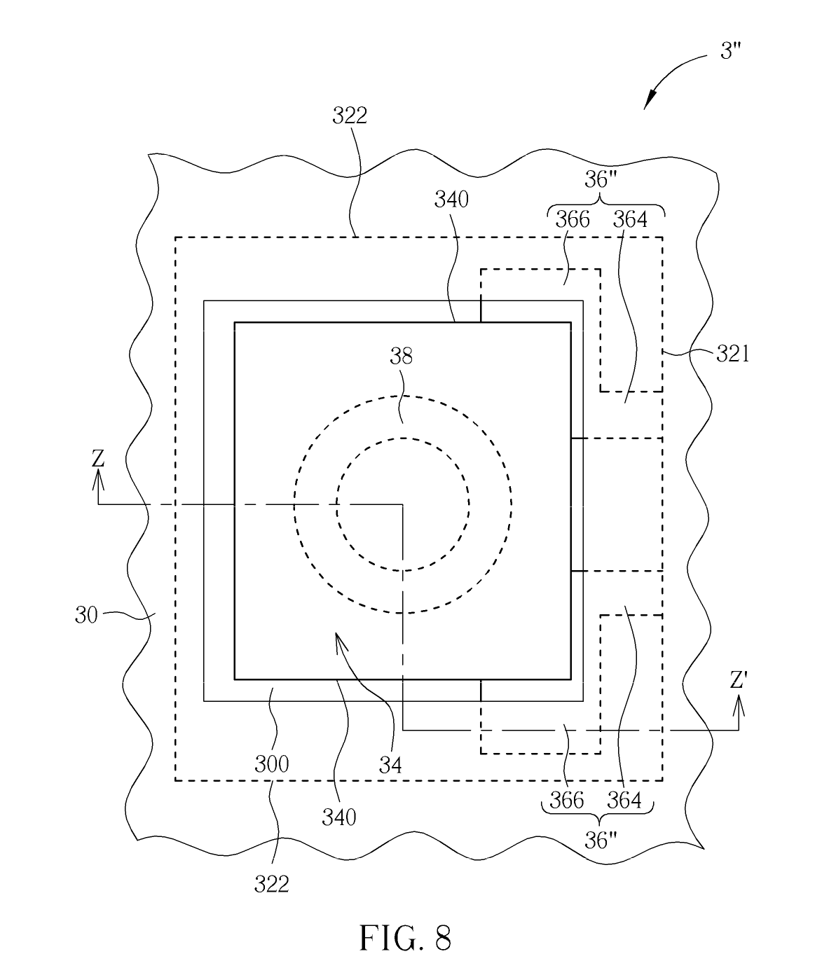

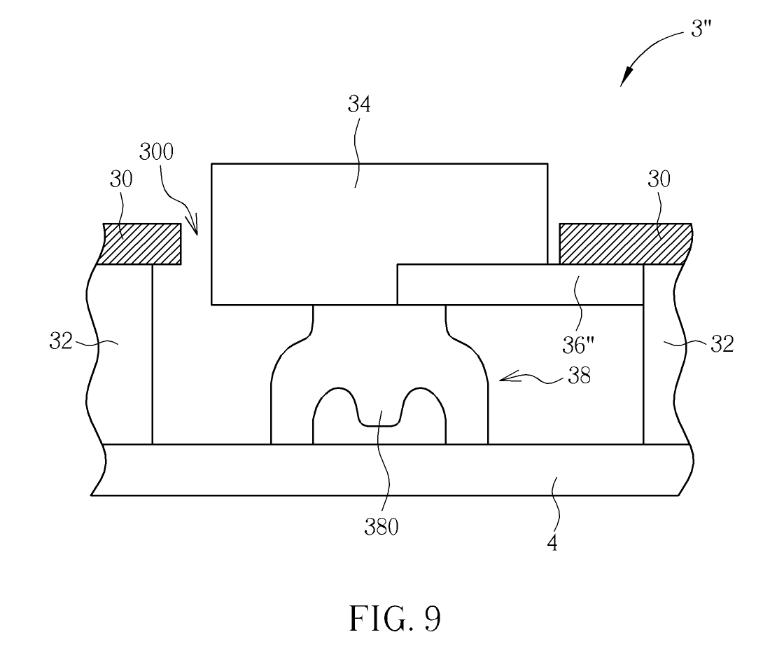

Please refer to FIG. 8 and FIG. 9, FIG. 8 is an illustration of the top view of a keyswitch 3″ according to a third embodiment of the invention, and FIG. 9 is an illustration of the cross-sectional view of the keyswitch 3″ along Z-Z′ in FIG. 8. In the third embodiment, each of the connecting parts 36″ includes a connecting section 364 and a withstanding section 366. The connecting section 364 connects between a linking edge 321 of the frame 32 and the withstanding section 366, while the withstanding section 366 connects between the connecting section 364 and a corresponding edge 340 of the keycap 34. Similar with the previous embodiments, as the keycap 34 is forced to move downward and bounced back by the elastic piece 38, the two withstanding sections 366 of the connecting parts 36″ are abutted by the cover 30 such that the keycap 34 is restrained from move upward and out of the cover 30.

The keyswitch and the keyboard disclosed in the embodiments of the invention use the cover to abut against the connecting parts connecting between the keycap and the frame such that the keycap may well be restrained from moving overly upward and out of the cover. Fracture of the connecting parts and break of the keycap are avoided. Additionally, the design of connecting parts simplifies the structure of the keyswitch since the connecting parts function to be withstood and to connect as a same component. The frame, the keycap, and the connecting parts as a monolithical piece also reduce time and cost for assembly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch, comprising:
a cover, comprising an opening;
a frame disposed under the cover;
a keycap located in the opening, the keycap comprising two opposite edges;
two connecting parts, each connecting between one corresponding edge and the frame respectively and abutted by the cover such that the keycap is restrained from moving upward; and
a base disposed under the frame.

2. The keyswitch of claim 1, wherein the keycap has similar and smaller contour as the opening.

3. The keyswitch of claim 1, wherein the two connecting parts are L-shape, two end nodes of each connecting part connecting to corresponding edge and the frame respectively.

4. The keyswitch of claim 1, wherein the two connecting parts are L-shape, each connecting part comprising an end node connecting to the frame and a side connecting to the corresponding edge of the keycap.

5. The keyswitch of claim 1, wherein each of the two connecting parts comprises a connecting section and a withstanding section, the connecting section connecting between the frame and the withstanding section, the withstanding section connecting between the connecting section and corresponding edge of the keycap for being abutted by the cover such that the keycap is restrained from moving upward.

6. The keyswitch of claim 1, wherein the frame, the two connecting parts, and the keycap are monolithically formed as one piece.

7. A keyboard, comprising:
a base; and
a plurality of keyswitches disposed on the base, each keyswitch comprising:
a cover, comprising an opening;
a frame disposed under the cover;
a keycap located in the opening, the keycap comprising two opposite edges; and
two connecting parts, each connecting between one corresponding edge and the frame respectively and abutted by the cover such that the keycap is restrained from moving upward.

8. The keyboard of claim 7, wherein the keycap has similar and smaller contour as the opening.

9. The keyboard of claim 7, wherein the two connecting parts are L-shape, two end nodes of each connecting part connecting to corresponding edge and the frame respectively.

10. The keyboard of claim 7, wherein the two connecting parts are L-shape, each connecting part comprising an end node connecting to the frame and a side connecting to the corresponding edge of the keycap.

11. The keyboard of claim 7, wherein each of the two connecting parts comprises a connecting section and a withstanding section, the connecting section connecting between the frame and the withstanding section, the withstanding section connecting between the connecting section and corresponding edge of the keycap for being abutted by the cover such that the keycap is restrained from moving upward.

12. The keyboard of claim 7, wherein the frame, the two connecting parts, and the keycap are monolithically formed as one piece.
